(19) United States
(12) Patent Application Publication
(10) Pub. No.: US 2014/0125663 A1
(43) Pub. Date: May 8, 2014

(54) 3D MODEL SHAPE ANALYSIS METHOD BASED ON PERCEPTION INFORMATION

(71) Applicants: Xiaopeng Zhang, Beijing (CN); Xiaojuan Ning, Beijing (CN); Er Li, Beijing (CN); Yinghui Wang, Beijing (CN); Weiliang Meng, Beijing (CN)

(72) Inventors: Xiaopeng Zhang, Beijing (CN); Xiaojuan Ning, Beijing (CN); Er Li, Beijing (CN); Yinghui Wang, Beijing (CN); Weiliang Meng, Beijing (CN)

(73) Assignee: INSTITUTE OF AUTOMATION, CHINESE ACADEMY OF SCIENC, Beijing (CN)

(21) Appl. No.: 13/988,321

(22) PCT Filed: Dec. 3, 2010
(86) PCT No.: PCT/CN2010/001955

§ 371 Date: Nov. 26, 2013

(51) Int. Cl. G06T 17/00

(52) U.S. Cl. CPC G06T 17/00
USPC 345/420

(57) ABSTRACT

A method for analyzing a shape of a 3D model based on perceptive information comprises: decomposing the shape of the 3D model to generate decomposition results; and extracting a skeleton from the decomposition results. This invention can be applied to shape decomposition of objects having different shapes. The 3D models can be regular or with noise, containing either multiple annular structures or no annular structure. The decomposition method of this invention is not sensitive to noise, and the segmentation speed is high and accurate. The segmentation result of the invention can be widely applied to different branches of computer graphics and computer vision, such as computer animation, modeling, shape analysis, shape classification, object identification, etc. The skeleton extracted from the decomposition result and the following shape semantic description diagram can he applied to 3D model retrieval, model semantic analysis and so on.

### TECHNICAL FIELD

The present invention relates to pattern recognition, and particularly to a 3D model shape analysis method based on perception information.

### BACKGROUND

Shape decomposition refers to decomposition of an object with a regular 3D shape into meaningful parts. This is usually a challenging research topic which is essential for shape analysis, processing and application. 3D semantics obtained by the shape decomposition can be widely used in different branches of computer graphics and computer vision fields, including computer animation, geometric modeling, shape analysis, shape classification, object recognition and 3D model retrieval and so on.

In general, the most typical representation of a 3D shape is a grid model or a voxel model. Existing methods based on the grid models are dependent on topology information, such as edges, surfaces, etc., provided by the grid models. However, for polygon grid models, a large amount of topological connection information needs to be processed, which makes many researchers begin to question the validity of the polygon grid. Existing methods based on voxel models depends on topological relationships derived from regular distribution of the voxels in the shape analysis, and thus the application is limited.

With the development of 3D laser scanning systems, a new representation called 3D point cloud data began to emerge. It can express complex objects accurately in the real world. For this new kind of data representation, the existing grid model-based decomposition methods and voxel model-based decomposition methods are no longer applicable. A new method need to be designed for the shape decomposition based on the 3D point cloud model, which may also be applicable to the grid models and the voxel models.

The typical method for grid model decomposition is the grid hierarchical decomposition based on fuzzy clustering and cuts, which is proposed by S. Katz and A. Tal in 2003 (Sagi Katz, Ayellet Tal. Hierarchical mesh decomposition using fuzzy clustering and cuts, ACM SIGGRAPH 2003 Papers, Jul. 27-31, 2003, San Diego, Calif.), which gradually decomposes the grids down into small pieces at depth concaves. Golovinskiy and Funkhouser proposed a random cutting method for 3D mesh analysis in 2008 (Aleksey Golovinskiy, Thomas Funkhouser, Randomized cuts for 3D mesh analysis, ACM SIGGRAPH Asia 2008 papers, Dec. 10-13, 2008, Singapore). In this method, two points are selected randomly from the model as seed points and decomposition is implemented using S. Katz and A. Tal's method. Then seed points are selected repeatedly until a boundary line stable for many seed points is obtained, which means the boundary is the target boundary. These methods are not supported by semantic representation, so they cannot be used for the shape analysis of generic object data.

Typical decomposition methods for voxel models are proposed by Xiaopeng Zhang et al. in “A Method for Volume Decomposition and Hierarchical Skeletonization of Tree-like Shapes” (Chinese Patent No.: ZL200710062988.4), and in “A Rapid 3D Skeleton Extraction Method Based on Fork Features” (Chinese Patent Application No. 200910085185.X). Such methods cannot handle models having complex topology (or models containing noise) or non-voxel models, so they cannot be used for the shape analysis of the generic object data.

Besl, P J. and Jain, R. C proposed a variable-order surface fitting method for segmentation (Besl, P. J., and Jain, R. C. 1988. Segmentation Through Variable-Order Surface Fitting. IEEE Transaction on Pattern Analysis and Machine Intelligence 10, 2, 167-192). This method uses low-order bivariate polynomial to fit data points, and estimates the Gaussian Curvature and Mean Curvature. According to this method, after finding a core area, region growing method is employed to find all edges. Jiang et al. proposed using scanning lines to divide data into curves and then cluster all the curves to represent different surfaces (Jiang, X. Y., Bunke, H., and Meier, U. 1996. Fast range image segmentation using high-level segmentation primitives. In WACV '96: Proceedings of the 3rd IEEE Workshop on Applications of Computer Vision (WACV'96), IEEE Computer Society, Washington, D.C., USA, 83.). The former method is sensitive to noise, requires a lot of parameters, and is very time-consuming even when it is applied on a range image. Although the latter has a certain improvement in segmentation quality and segmentation speed, it is not suitable for segmentation of point cloud data.

Yamazaki et al. proposed a three-stage process to split the point cloud data (Yamazaki, I., Natarajan, V., Bai, Z., and Hamann, B. 2006. Segmenting point sets. In: IEEE International Conference on Shape Modeling and Applications, 2006.) The first stage is feature recognition by roughening input super node(s); the second stage is level-splitting, which clusters similar super-nodes into a same group; and the last stage is to further refine the splitting result to ensure that each split region contains at least an important feature. This method can effectively obtain geometric features of the complex point cloud data, but its time complexity is relatively high. Based on the work of Yamazaki et al. in 2006, Zou and Ye proposed a hierarchical point cloud segmentation method based on multi-resolution analysis (Zou, W., and Ye, X. 2007. Multi-Resolution Hierarchical Point Cloud Segmenting In IMSCCS '07: Proceedings of the Second International Multi-Symposiums on Computer and Computational Sciences, IEEE Computer Society, Washington, D.C., USA, 137-143). This method first constructs a BVH to simplify the model, and then uses fuzzy clustering method to split the point cloud data. Although the method can handle large-scale point cloud data, it is prone to generate rough boundaries. Reniers and Telea proposed segmenting the point cloud based on skeleton (Reniers, D., and Telea, A. 2007 Skeleton-Based Hierarchical Shape Segmentation In SMI '07: Proceedings of the IEEE International Conference on Shape Modeling and Applications 2007, IEEE Computer Society, Washington, D.C., USA, 179-188.) The method is based on the shape of the voxel, and cannot be fully applied to the point cloud data. Richtsfeld and Vincze proposed decomposing 3D objects by hierarchical segmentation based on reflection variations (Richtsfeld, M., and Vincze, M. 2009. Point Cloud Segmentation Based on Radial Reflection, in Computer Analysis of Images and Patterns, Springer-Verlag, Berlin, Heidelberg, 955-962.) The method extracts core points by calculating smallest enclosing balls, then segments the point cloud using the area filling method, and optimizes segmentation results by using normal vectors. The method is only useful for those data in which core parts can be extracted.

### SUMMARY

The present invention provides a method for analyzing a shape of a 3D model based on perceptive information.

As such, a method for analyzing a shape of a 3D model based on perceptive information comprises:

decomposing the shape of the 3D model to generate decomposition results; and extracting a skeleton from the decomposition results.

This invention can be applied to shape decomposition of objects having different shapes. The 3D models can be regular or with noise, containing either multiple annular structures or no annular structure. The decomposition method of this invention is not sensitive to noise, and the segmentation speed is high and accurate. The segmentation result of the invention can be widely applied to different branches of computer graphics and computer vision, such as computer animation, modeling, shape analysis, shape classification, object identification, etc. The skeleton extracted from the decomposition result and the following shape semantic description diagram can be applied to 3D model retrieval, model semantic analysis and so on.

### BRIEF DESCRIPTION OF THE DRAWINGS

FIG. 1 shows a flowchart of an overall algorithm of the present invention, i.e., an overall method for analyzing a shape of a 3D model;

FIG. 2 shows a decomposition process for the 3D model according to the present invention;

FIG. 3 shows a skeleton extraction process for the 3D model according to the present invention;

FIGS. 4a to 4h show respective results of all stages in the entire process of the invention;

FIGS. 5a to 5d show a process of a contour point extraction algorithm and results for the model according to the present invention;

FIGS. 6a and 6b show the results of convex hull calculation and block feature point selection according to the present invention;

FIGS. 7a to 7c show the results of surface skeleton point extraction according to the present invention;

FIGS. 8a and 8b show centralized skeleton extraction results according to the present invention;

FIGS. 9a to 9d show decomposition-level skeleton extraction results according to the present invention;

FIGS. 10a to 10c show a process for determining a boundary between each area according to the present invention;

FIGS. 11a to 11c show surface skeleton point extraction results of an object with an “annular portion” according to the present invention;

FIGS. 12a to 12c show a structure of a final shape semantic description according to the present invention;

FIGS. 13a and 13b show a time performance analysis diagram of the shape decomposition algorithm according to the present invention;

FIGS. 14a and 14b show the experimental results of the shape decomposition algorithm which are robust to noise, according to the present invention;

FIG. 15 shows examples of a series of shape decomposition results;

FIG. 16 shows a shape decomposition process of a ‘Bunny’ model according to the present invention.

FIGS. 17a to 17c show skeleton extraction results of a ‘hand’ model according to the present invention.

FIGS. 18a to 18d show skeleton extraction results of a ‘horse’ model according to the present invention.

FIGS. 19a to 19d show comparison results between the shape decomposition algorithm according to the present invention and other methods.

### EMBODIMENTS

Next, the present invention will be described in detail with reference to the accompanying drawings. It should be noted that the described embodiments are only intended to facilitate the understanding of the present invention, rather than constitute any limit thereto.

1. Overview of a Method for Analyzing a Shape of a 3D Model Based on Perceptional Information

As shown in FIG. 1, a method according to the present invention conducts shape decomposition on a 3D model based on block feature points and curvature variations, and then constructs 3D skeleton points of an object from results of the shape decomposition, in order to obtain structural information of the 3D model. The structural information, including a relationship between the shape decomposition results and the skeleton description, is used to establish a shape semantic description of the 3D model. The feature information used for analyzing the shape of the 3D model is mainly perceptual information.

2. Shape Decomposition Process of the 3D Model

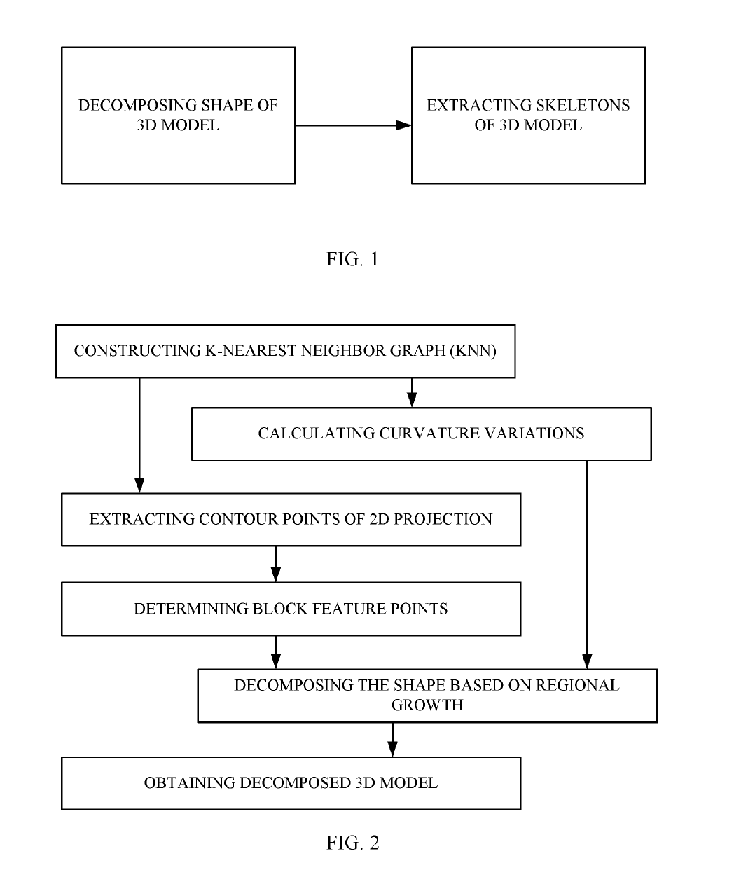

The shape decomposition process of the 3D model is mainly based on selection of block feature points, curvature variations, and minimum constraining method as shown in FIG. 2.

2.1 Construction of k-Nearest Neighbor (kNN) Graph

The construction for the k-nearest neighbor (kNN) Graph is: for an arbitrary point p, searching a set of k-nearest neighbor points Q={q₂, . . . , qₖ} in a k-d-tree, and then creating a k-nearest neighbor graph (undirected graph) for the point p and the nearest neighbor point set Q. The kNN graph is used for the subsequent geodesic distance calculation, and a typical value of k is 10.

2.2 Extraction of 2D Projection Contour Points

Usually, block feature points are located in parts with local maximum curvatures, and typically appear on the contour or on the boundary of the 3D object. Therefore, determination of these contour points is a very critical step. In this section, the inventors have proposed a method for extracting a boundary contour of a 2D projection of the 3D model, and all of the contour points (Silhouette Points) will be saved in a data set S={s₁, s₂, . . . , S_{φ}}, wherein φ is a number of the contour points.

First, the original model is projected on an optimal 2D plane at which the projection of the model has smallest deformation. Assuming p is an arbitrary point in an original 3D model P, k-nearest (k=15, . . . , 30) neighbor points within a distance range of 2*r are searched, and a set of these points are denoted as Q={q₁, q₂, . . . , qₖ}. Then an arbitrary point qᵢ from Q is selected and a circle through the points p and qᵢ can be calculated using p, qᵢ, with a given radius r. If p is a point on the contour, it must satisfy: among all the circles H₁, H₂, . . . , Hₖ constructed by the point p and a respective nearest neighbor point, for each circle Hᵢ, the distance from any of the rest of nearest neighbor points to the center of the circle is larger than the radius r, wherein i=1, 2, 3, 4, . . . , and k. Repeating the above procedure for each point in the 3D model, until all the contour points on the model are found, so as to obtain a set of boundary contour points S={s₁, s₂, . . . , s_{φ}}.

2.3 Determine Block Feature Points

The determined contour points need to be constrained in order to obtain the block feature points for identifying the 3D model, i.e., points with relatively large principle curvature (with +/−), which are located in convex parts and should be retained as much as possible. To this end, this object can be achieved by using a simple convex hull as follows:

A convex hull for the acquired set of boundary contour points S is calculated and denoted as Hₚ.

For each point in Hₚ and a given distance threshold Dₜₕ, k-nearest neighbor clustering is executed. Each clustering is subject to the statistic operation and clusters in which a relatively small number of points are removed as noise. Then, in each of the remaining clusters, a point with a maximum curvature is selected as the block feature point. In this way, a set of block feature points is calculated to get T={t₁, t₂, . . . , tₘ}.

2.4 Calculate Curvature Variation

The curvature variation can be calculated as follows:

(1) Calculating curvature: for each point p in the 3D model, the k-nearest neighbor points qᵢ (xᵢ, yᵢ, zᵢ) is searched, and then a centroid point of the k+1 points (including p itself denoted as q₀) is calculated as:

$$\overline{p} = \frac{1}{k + 1} {\sum }_{i = 0}^{k} {q}_{i}$$

A matrix is constructed as:

$$E = {\sum }_{j = 1}^{N} ( {p}_{j} - \overline{p} ) {( {p}_{j} - \overline{p} )}^{T} ,$$

in which pᵢ represents an arbitrary point in the entire model. Solving the matrix to obtain three eigenvalues λ₀, λ₁, and λ₂, and the curvature value κ (p) for each point can be estimated as:

κ(p)=λ₀(λ₀+λ₁+λ₂).

Here, λ₀≦λ₁≦λ₂. The curvature value thus calculated is not exactly the same as the principal curvature value, but may have the same function as the value of the relatively small principal curvature, i.e., indicating the degree of the curvature (convex-concave degree) of the surface.

(2) Using the curvature value x (p) of each point, the curvature variation Ω (p) of the point can be calculated to evaluate the smoothness of the region where the point and its nearest neighbor points locate. The curvature can reflect convex-concave changes in the 3D model, which in turn can be used to determine whether a point is located on a smooth surface. The curvature variation Ω (p) can be calculated as follows:

$$Ω ( p ) = \frac{1}{k} {\sum }_{i = 1}^{k} {( {κ}_{i} - \overline{κ} )}^{2} ,$$

in which κ̅=Σ_{i=1κi}^{k}k, which denotes an average curvature of all the k-nearest neighbors of the point p, and κᵢ=κ(qᵢ). If the point is located on a smooth surface, the Ω (p) of this point is very small.

2.5 Shape Decomposition Based on the Regional Growth

Shape decomposition based on the regional growth is calculated based on the curvature variations calculated in Section 2.4. The shape decomposition based on the regional growth can be calculated as follows:

(1) For an arbitrary point tᵢ in the set of block feature points T, k-nearest neighbor points qᵢ is searched for clustering, and these k-nearest neighbor points are sorted according to their curvature values in descending order;

(2) A point with the maximum curvature is selected as a seed point to start the regional growth. Those points whose curvature variations are less than a threshold kₜₕ are sorted into the same cluster as the seed points. This process is repeated for all the block feature points;

(3) If the seed point and its nearest neighbor points have been identified, and there is unidentified points in the entire data, the algorithm needs to select a point with a maximum curvature value among the unidentified points as a seed point to repeat the regional growth process, until all the points of the object are identified;

(4) This process is repeated until each point has been identified with a clustering number;

(5) A final shape decomposition result is generated.

Using the decomposition method for the 3D model proposed in this invention, decomposition parts of the 3D models can be obtained that are independent of each other.

3. Skeleton Extraction Based on Shape Decomposition

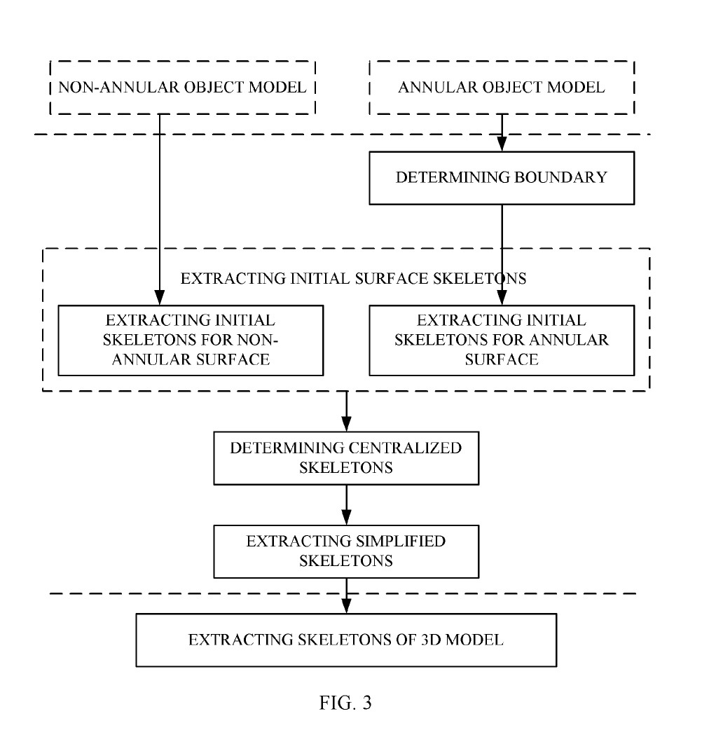

Objects can be classified into annular models or non-annular models. In order to determine skeleton points of the different models, these two cases will be discussed, as shown in FIG. 3. Initial surface skeleton points include annular surface skeleton points and non-annular surface skeleton points.

The initial surface skeleton points can be determined by extracting surface skeleton points based on the shape decomposition of the object. As a result, the initial surface skeleton is formed by connecting a series of initial identified points. It comprises the shortest paths from a center point O of the model and the set of block feature points T={t₁, t₂, . . . , tₘ}.

For each point in the model, the center point of the model is determined by calculating the sums of geodetic distances from this point to each of the other points in the model, and selecting the point with the minimum sum of the geodetic distances as the model center point.

The shortest path from each point in the set of block feature points T to the center point O of the model is a Dijkstra shortest path.

The surface skeletons are determined by connecting the center point O with each block feature point tᵢ. The surface skeleton comprises a plurality of points each having a decomposition identifier ID. For the annular object models, it is necessary to determine boundaries, as discussed in Sections 3.2 and 3.3.

3.1 Extraction of Initial Skeletons for Non-Annular Surface

The extraction of the initial skeletons for a non-annular surface is as follows:

(1) Constructing a function for measuring centrality of the model:

g(p)=Σ_{p∈P}G²(p, pᵢ).

Here, p is a point in the model, pᵢ is another point in the model, and G² (•, •) represents the geodetic distance between the two points. The geodesic distance can be calculated as follows: for two arbitrary points in the kNN graph, the length of a path connecting the two points via the shortest edge(s) is the geodesic distance between the two points. The function can determine the center point O of the model, that is, the point having the smallest value of g among all the vertices of the model.

(2) Estimating the shortest path from each block feature point in T to the center point of the model using Dijkstra shortest path algorithm, and taking the points located on the paths as the initial surface skeletons L={L₁, L₂, . . . , Lₖ} of the model.

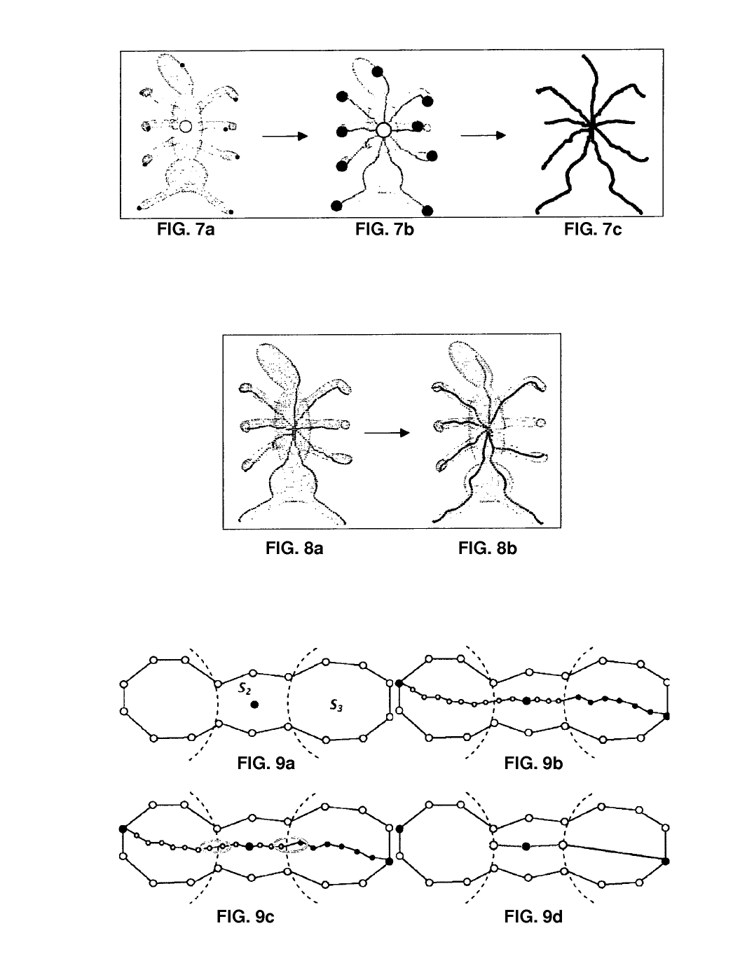

As shown in FIG. 7a and FIG. 7b, the points located on convex parts of the model are identified as the block feature points, and the point at the center of the model is the central point O. FIG. 7b shows the shortest paths connecting the block feature points to the center point, and the surface skeleton points are shown in FIG. 7c.

3.2 Determination of Boundary for Extracting Annular Skeletons

In order to extract the annular skeletons, boundaries need to be determined for the decomposed model. Points on the boundary can be determined as follows.

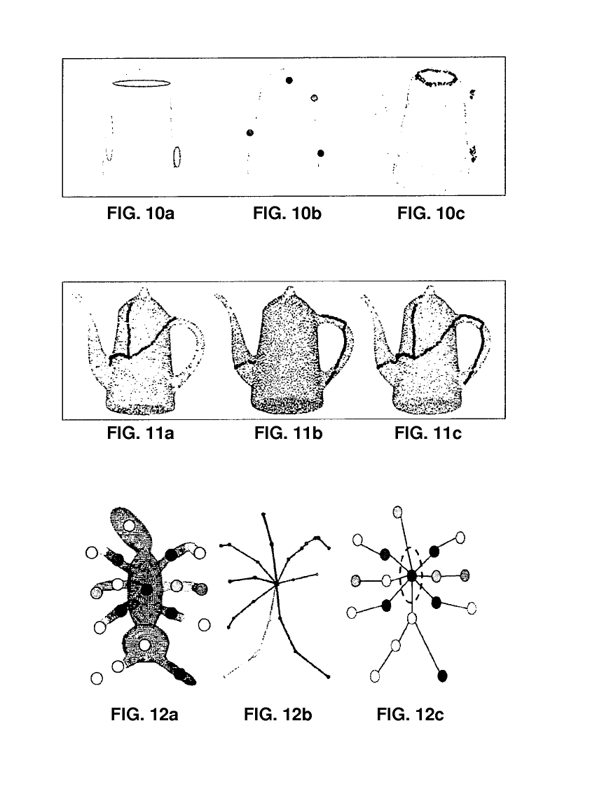

(1) For two different decomposition regions Ri and Rj (corresponding reference identifiers are i and j respectively), points where an identifier change occurs are recognized as boundary points, as shown in FIG. 10a-10b.

(2) Determining changes of the identifiers of the nearest neighbor points with respect to the boundary point and counting frequency of the changes. Points with the identifier i or j in the set of nearest neighbor points are determined as points on the boundary. This process is repeated to determine all the boundaries, as shown in FIG. 10c.

A set of connecting points J={ρ₁, ρ₂, . . . ρₘ₋₁} of two adjoining decomposition parts is obtained by detecting the changes of the identifiers of the skeleton points (as shown in FIG. 10b). For each point in J, regional growth process is executed using the identifiers of the nearest neighbor points as a constraint condition. Points satisfying the condition are considered to be the points on the boundary.

For two decomposition parts S1 and S2, a connection point is calculated and denoted as ρ. Growth is executed using ρ as the initial seed point. If the k-nearest neighbor points comprises both identifier i and j but no other identifiers, the k-nearest neighbor points is deemed as the boundary. In this way, all the boundaries in the model can be determined. For the “annular” part, two boundaries are obtained and clustered using the k-nearest neighbors to obtain two independent boundaries, as shown in FIG. 10c.

3.3 Extraction of Initial Skeletons of Annular Surface Based on Boundaries

The previously mentioned method for extracting the initial surface skeletons is to find the shortest paths from the block feature points to the center of the model. This method has certain disadvantages with annular models. In order to solve this problem, the inventors proposed a skeleton extraction method for the annular object based on the boundaries. According to this method, topology information of the annular part can be obtained by determining the boundaries and selecting a point from each boundary as the connection point.

The initial skeletons of the annular surface can be determined as follows. First, the centroid point of each boundary surface is determined, and then shortest paths from the block feature points to the centroid point of the boundary and a shortest path from the boundary centroid point to the center point of the model are calculated respectively. The points on these paths form the initial surface skeleton points of the annular object.

Using the central point of the 3D model, the centroid point of each boundary surface, and the block feature points of the 3D model, the initial surface skeletons of the 3D model containing the annular part are determined as shown in FIG. 11a-11c.

3.4 Determination of Centralized Skeletons

The centralized skeletons are obtained by moving all nodes of the aforementioned initial surface skeletons (the initial skeletons of the non-annular surface or the initial skeletons of the annular surface) toward the center of the object, which are illustrated as follows.

Each point on the initial surface skeletons is moved using a 3D model skeleton pushing method from the surface to the inside of the model.

Assuming the set of the initial surface skeletons is denoted as L={L₁, L₂, . . . , Lₘ}, and for an arbitrary point η_{i,j} on skeleton the point is moved by a certain distance toward the inside of the model in a direction opposite to the normal vector of ηᵢⱼ. Then the following push operation is repeated:

η_{i+1,j}=η_{i,j}+normalize(W_{F}(η_{i,j}))*e.

Function nomalize( ) represents normalization of the vector, and e is a step length defined by the user. W_{F} is the pushing force, and its value is determined by the following formula:

$${W}_{F} ( x ) = {\sum }_{{q}_{i} ∈ V ( x )} F ( {‖ {q}_{i} - x ‖}_{2} ) \cdot ( {q}_{i} - x )$$

Here, F(r)=1/r² is a Newton potential energy function. V (x) denotes the set of k-nearest neighbor points of x, i.e., V (x)={q₁, q₂, . . . , qₖ}. ∥·∥₂ represents the length of the vector. For each point η_{i,j} on the skeleton Lᵢ, the pushing process is terminated when the following condition is met:

|W_{F}(η_{i+1,j})|>|W_{F}(η_{i,j})|

This is the condition for each point on the skeleton Lᵢ to terminate the pushing process. Once the pushing process is terminated for one point, the pushing process for another point is started. The pushing process can move the surface skeleton points toward the center of the model. FIG. 8a shows the initial surface skeletons. After the pushing process, there are many “jags” in the skeletons, and therefore a smoothing process is necessary. If the intersection angle of two consecutive segments η_{i,j-1}η_{i,j} and η_{i,j-2}η_{i,j-1} on the skeleton is greater than a preset threshold value, the smoothing process will be performed. In this case, a new node (η_{i,j-2}+η_{i,j})/2 is used to get smooth skeletons as shown in FIG. 8b. The path (skeleton) starts from the respective block feature points to the center point of the model, and the resulted smooth skeletons are saved as C={C₁, C₂, and . . . , Cₘ}, in which each skeleton contains many new nodes Cᵢ={η_{i,1}, η_{i,2}, . . . , η_{i,τ}}.

3.5 Extraction of Simplified Skeleton Based on Decomposition

The simplified skeleton can be extracted based on the shape decomposition and the centralized skeleton. For an original model S, all parts obtained from the shape decomposition are denoted as S₁, S₂, . . . , Sₖ, each being assigned with an identifier. For each part Sᵢ, a center point Cᵢ is calculated, and each section of skeleton can be determined according to the identifiers of the decomposition result. Then changes of the identifiers of the skeleton points are detected between regions. In the detection process, if these center points Cᵢ are connected directly, the skeletons may deviate from the center of the object, so it is necessary to add some intermediate points to ensure the centrality. Under the premise of ensuring the skeleton being located inside the model, the skeleton points between two points where the identifiers change are deleted to obtain a simplified skeleton.

In Section 3.4, the set of smooth skeletons C={C₁, C₂, . . . , Cₖ} is obtained. In order to ensure the smoothness of the skeletons and using fewer nodes to represent the model skeletons, the invention proposes a method for extracting the simplified skeletons based on the decomposition. FIG. 9 shows an example of this method which divides a model into three parts. The method is generally explained as follows:

(1) First, different decomposition parts are identified. As shown in FIG. 9a, it is assumed that the original shape is decomposed into three parts S₁, S₂, and S₃, and the circle in S₂ indicates the center point O.

(2) For the block feature points of each part (except the part where the center point is located), shortest paths between each block feature point to the center point is determined and identified with the decomposition identifier, as shown in FIG. 9b;

(3) Changes of the identifiers on the path are detected to determine Joint/Junction of two different parts, as shown in FIG. 9c. Then, points on the path of different decomposition parts are simplified according to the Joint/Junction. In order to guarantee that these points are inside the model, some transition points are needed. Eventually a corresponding set of simplified skeletons D₁, D₂, . . . , Dₘ is obtained, as shown in FIG. 9d.

4. Construction of Shape Semantic Description Graph

The shape skeletons can provide intuitive and effective simplification for the model, and thus is useful for representation, description, and operation of the model. In this section, a shape semantic description graph is constructed based on the shape decomposition result and the extracted skeleton. The shape semantic description graph can be used to describe the topological relationship among the decomposed parts of the model. The shape semantic description graph of the model can describe the topological relationships of object, with a wide range of applications, such as 3D model retrieval.

The shape semantic description graph herein is a representation of the topological relationships of the object, and can be expressed as G=<V, E>, where V is a node in the graph, and V={V₁, V₂, V₃, . . . , Vₖ}. V; corresponds to the decomposition part Sᵢ, which in turn corresponds to a node Vᵢ. E={E₁, E₂, . . . , Eₖ₋₁ describes the topological relationship between two decomposition parts as to whether they are adjacent to each other. E is determined by detecting the identifier change of the skeleton points to determine the connectivity between the two decomposition parts. If the skeleton points go through the two parts with an identifier change, there must be an edge between the two points, and the shape semantic description graph of the entire model can be obtained.

FIG. 12a shows a decomposition result of the data of “Ant.” A node is set for each part, and adjacency relationships among the respective parts can be obtained from the skeletons and connection nodes (FIG. 12b). Next a center point O of the model is found, which corresponds to a core point V_{O} in the semantic graph (generally the largest part of the model). According to the connection relationships, the semantic graph of the model can be determined starting from the point V_{O}, as shown in FIG. 12c.

### Experimental Results and Conclusions

The method described herein is implemented using C++ language on a plurality of different data sets. All experiments are executed on a PC with a P4 2.4G CPU, 1G memory, and the Windows XP operating system. Display is implemented using the standard OpenGL graphics library.

In the experiments, 10 different data sets are used to test the shape decomposition algorithm. Two data sets are used for the skeleton extraction, as well as the subsequent semantic graph description. The time complexities of various stages of shape decomposition algorithm are listed as follows:

k-nearest neighbor points: O (knlog (n));

Boundary Extracting: O (nlog (n));

Clustering for determination of the block feature points: O (nlog (n));

Determination of the block feature points: O (log (n));

Decomposition process: O (n2log (n)),

where n represents the number of the points of the model, and k represents the number of the nearest neighbor points.

For the implementation of the algorithm, k=30, and the distance threshold Dₜₕ is obtained by multiplying a minimum distance (MinDist) from the point to the neighbor points with a coefficient. The range of the angle threshold θ_{T} for plane consistency condition is 10°˜15°. The curvature variation threshold kₜₕ is determined by the distribution of the curvature variations of all the points of the data, and a middle value is taken as the threshold value.

Table 1 lists the experimental data of the shape decomposition algorithm, including the number of points in the original data, the number of extracted contour points and the number of the block feature points. In addition, the table shows the running time for the various stages of the shape decomposition algorithm (including k-nearest neighbor graph (kNN), boundary extraction (Bou), boundary points clustering (Clu), block feature points determination (Cri), and shape decomposition process (Seg)).

TABLE 1
Experimental Data Analysis of the Shape Decomposition

| | | Number of | Set of | | | | | |
|---|---|---|---|---|---|---|---|---|
| | Data | Contour | Feature | | | | | |
| | Volume | Points | Points | Running Time | | | | |
| Data Sets | N | Cₚ | M_{S} | kNN | Bou | Clu | Cri | Seg |
| Octopus | 5944 | 468 | 9 | 0.01 | 2.625 | 0.015 | 2.609 | 2.656 |
| Ant | 8176 | 428 | 9 | 0.015 | 3.594 | 0.031 | 0.016 | 4.609 |
| Bunny | 34835 | 708 | 6 | 0.11 | 15.46 | 0.094 | 0.09 | 95.484 |
| Table | 13579 | 562 | 4 | 0.047 | 6.1 | 0.06 | 0.015 | 12.172 |
| Cactus | 620 | 98 | 3 | 0.0 | 0.2 | 0.047 | 0.0 | 0.047 |
| Hand | 11413 | 332 | 6 | 0.02 | 5.0 | 0.31 | 0.032 | 7.625 |
| Tippy | 9548 | 556 | 8 | 0.01 | 4.2 | 0.07 | 0.01 | 6.84 |
| Horse | 8078 | 356 | 8 | 0.015 | 3.906 | 0.025 | 0.016 | 4.75 |
| Teapot | 6678 | 184 | 4 | 0.016 | 3.328 | 0.063 | 0.001 | 3.437 |
| Vase | 14989 | 804 | 10 | 0.021 | 5.719 | 0.172 | 0.016 | 16.781 |

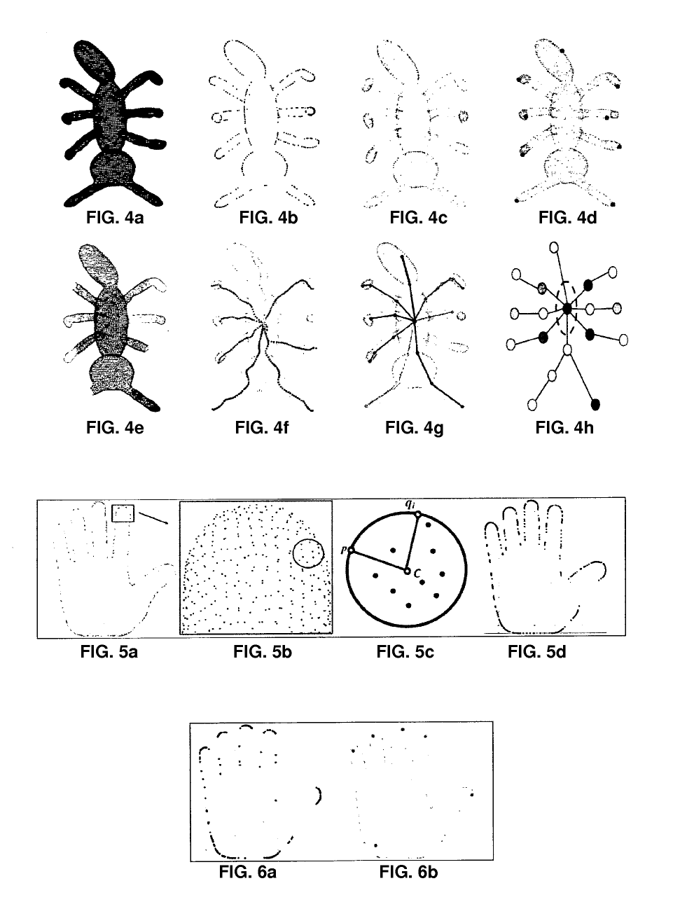

FIG. 4a-FIG. 4h show the shape decomposition process, the skeleton extraction result and the semantic description graph of the Ant data, respectively. FIG. 4a shows the original data of Ant. FIG. 4b shows the contour points of Ant. FIG. 4c shows the convex hull of the contour points and the clustering result. FIG. 4d shows the block feature points. FIG. 4e shows a region decomposition result. FIG. 4f shows surface skeleton points. FIG. 4g shows simplified skeletons. FIG. 4h shows the final semantic description graph.

FIG. 5a-FIG. 5d show the model contour point extracting process and results respectively. FIG. 5a shows the original “Hand” model. FIG. 5b shows a partially enlarged area. FIG. 5c shows a local circle control diagram. FIG. 5d shows the final contour point extraction result.

FIGS. 6a and 6b show the convex hull of the Hand contour points and the selection result of the block feature points respectively, wherein the block feature points are represented by the bold points in FIG. 6b.

FIG. 7a-FIG. 7c respectively show the surface skeleton point extraction process and the final result. The center point of the model and the block feature points of the original Ant data are shown in FIG. 7a. FIG. 7b shows the shortest path that connects each block feature point to the center point of the model. The final surface skeleton point result is shown in FIG. 7c.

FIGS. 8a and 8b show the initial surface skeleton points and the centralized skeleton of the model, respectively.

FIG. 9a-FIG. 9d show the diagram of different stages of the skeleton extraction. FIG. 9a shows presumed decomposition region data S₁, S₂, and S₃. FIG. 9b shows the block feature points of each region as well as the shortest paths from the block feature points to the center of the model. FIG. 9c shows the connection points determined by regional identifier change. FIG. 9d shows the final result of the decomposed simplified skeleton.

FIG. 10a-FIG. 10c show the process to determine the boundary. FIG. 10a shows the boundary between the decomposed regions. FIG. 10b shows the points where identifier changes occur between the detected regions. FIG. 10c shows the results of the final boundary.

FIG. 11a-FIG. 11c show the extraction of the surface skeleton points of objects with an annular structure. FIG. 11a shows the shortest paths from the boundary centers to the center of the model. FIG. 11b shows the shortest paths from the block feature points to the corresponding boundary center. FIG. 11c shows the final surface skeleton points of the Teapot data, which proves the effectiveness of this method. That is, this method can process not only the regular-shape objects but also the objects with the annular structure(s).

FIG. 12a-FIG. 12c show the construction process of the shape semantic graph. FIG. 12a shows determining a representative node for each part based on the shape decomposition result. The skeleton of the model is given in FIG. 12b. FIG. 12c gives the final semantic graph of the model.

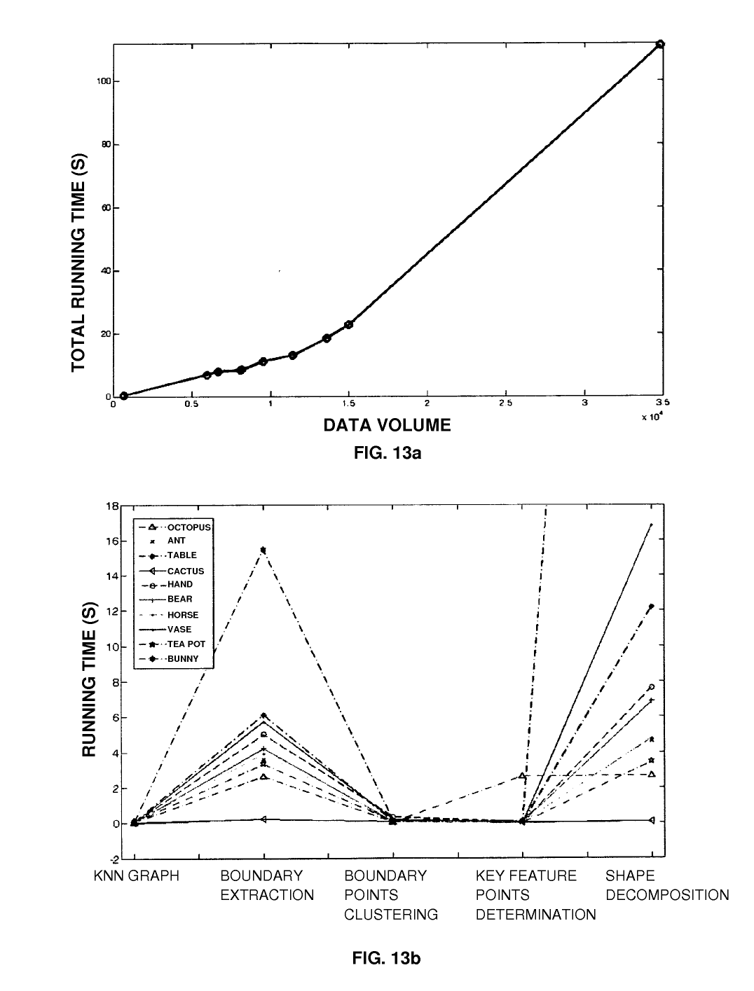

FIG. 13a and FIG. 13b show the time performance analysis of the shape decomposition algorithm. FIG. 13a shows that the relationship between the size of the data sets and the running time. FIG. 13b shows the running time for the various stages of the shape decomposition for different data sets.

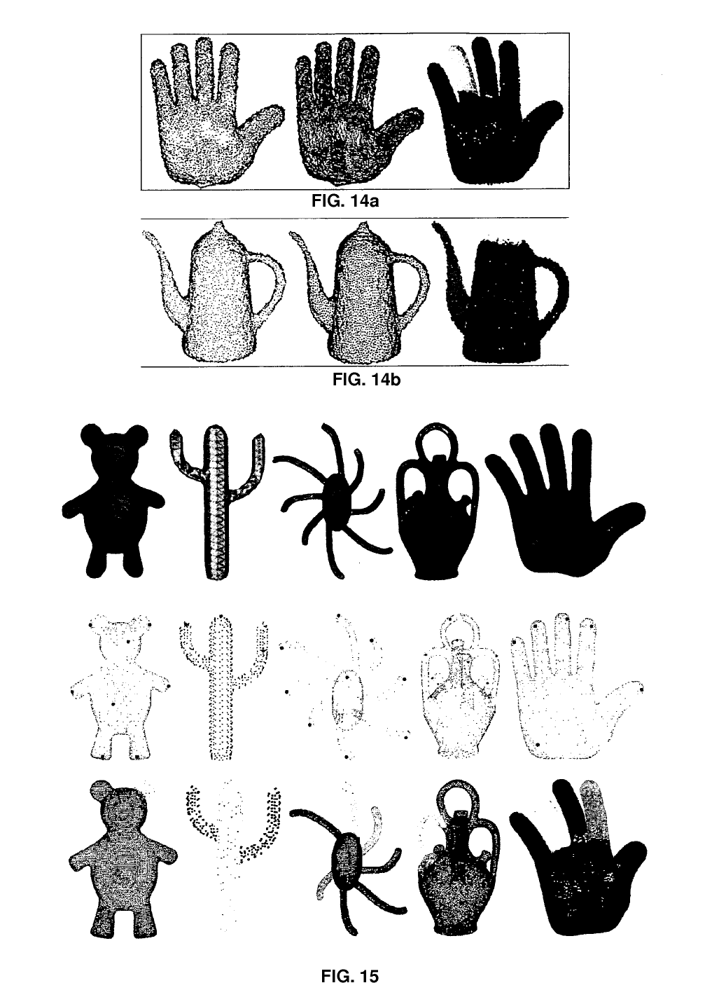

FIG. 14a and FIG. 14b respectively show the decomposition results of the “Hand” model and the “Teapot” model after adding noise to the models. This validates that the shape decomposition method according to the present invention is robust to the noise.

FIG. 15 shows the results of the shape decomposition of some objects. The first row is the original 3D model data. The second row is the result of determination of the block feature points of each model. The third row is the final shape decomposition result based on the feature point blocks for each model.

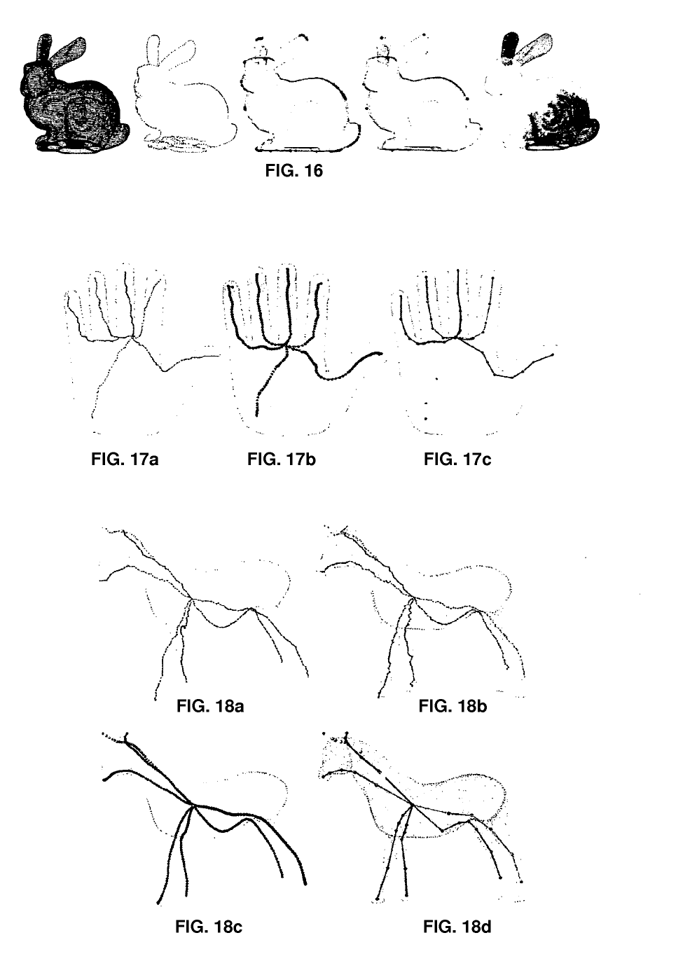

FIG. 16 shows the shape decomposition process of the “Bunny” data. From left to right, the figure shows the original “Bunny” data, the extracted contour points, the convex hull of the contour and clustering, the block feature points determination, and the final shape decomposition result.

FIG. 17a-FIG. 17c respectively show the surface skeleton points, the centralized skeleton decomposition, and the simplified skeletons of the “Hand” data.

FIG. 18a-FIG. 18d show the surface skeleton points, the centralized skeletons, the smoothed skeletons, and the decomposed simplified skeleton result of the “Horse” data.

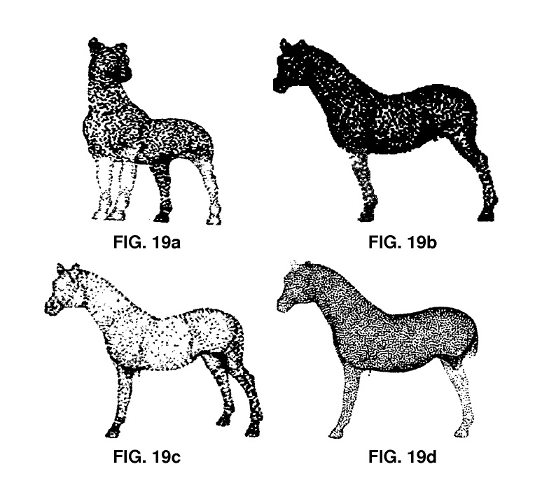

FIG. 19a-FIG. 19d show the comparison result of the shape decomposition algorithm of the invention with other methods. FIG. 19a shows the SPS method. FIG. 19b shows the SFS method. FIG. 19c shows the SRR method. FIG. 19d shows the shape decomposition method according to the present invention. It can be seen that the method of the present invention can extracted more details out of the model.

The feature and innovation of this method can be generally summarized as follows. According to the human perception of information and the minimum value rules, shape decomposition of the 3D model is executed by determining the block feature points of the object to direct the regional growth based on the curvature variations. The shortest paths from the model center to the block feature points are taken as the surface skeleton points of the model and centralized skeletons are obtained by moving the skeleton points toward the center of the model along the opposite direction of the normal vector of the surface skeleton point. Then the skeleton points are identified using the identifiers of the decomposed parts to obtain hierarchical skeletons. After smoothing and simplifying the skeletons, the final decomposition simplified skeletons can be obtained. Based on the shape decomposition results and the analysis of the semantic information of the model, Semantic Graph (SG) is used to represent the relationships among the various parts of model, and SG can be used for semantic feature descriptions, 3D retrieval of the model, and other relative fields.

Many of 3D shape analysis software only take into account the 3D model shape decomposition or segmentation operation. None of the subsequent works are considered. The shape decomposition method, the skeleton extraction method, and the final semantic graph structure in this invention can effectively decompose the 3D models with regular structures, and the skeleton extraction and topology analysis can be achieved based on the decomposition, which in turn provide important data for the semantic analysis, the deformation, and retrieval of the model, as well as the data support for subsequent reconstruction of point cloud models (including the reconstruction of the details) and identifying. The method of the invention can easily obtain the shape decomposition of the 3D model, the topology relationship and the description of the semantic information, and generates the data used in the software for subsequent analysis and processing.

The above are only specific embodiments of the present invention, and the protection scope of the present invention is not limited thereto. Any modification or substitution without departing from the spirit and principle of the present invention will shall fall within the protection scope of the present invention. Therefore, the protection scope of the present invention shall be defined by the claims.

1. A 3D model shape analysis method based on perception information, comprising:
decomposing a shape of a 3D model to generate a decomposition result; and
extracting skeletons according to the decomposition result.

2. The method according to claim 1, wherein decomposing the shape of the 3D model comprises:
constructing a k-nearest neighbor graph;
extracting contour points of a 2D projection of the 3D model;
determining block feature points;
calculating curvature variations; and
decomposing the shape based on regional growth.

3. The method according to claim 1, wherein the extracting skeletons comprises:
extracting initial skeletons for a non-annular surface;
determining a boundary;
extracting initial skeletons for an annular surface;
determining centralized skeletons; and
extracting simplified skeletons.

4. The method according to claim 2, wherein the constructing the k-nearest neighbor graph comprises:
establishing the k-nearest neighbor graph for a point p and a set of its k-nearest neighbor points Q by searching the set Q using a k-d tree, wherein the point p is an arbitrary point in the k-nearest neighbor graph.

5. The method according to claim 2, wherein the extracting contour points of a 2D projection of the 3D model comprises:
projecting all points in the original 3D model onto an optimal 2D plane of the model;
calculating a contour point p, wherein respective distances between all nearest neighbor points of the contour point p and a circle center are larger than a radius; and
repeating the above steps to obtain a set of the contour points S.

6. The method according to claim 2, wherein the determining block feature points comprises:
determining a convex hull Hₚ for the set of contour points S;
for each point in Hₚ, clustering k-nearest neighbor points thereof based on a given distance threshold Dₜₕ;
conducting statistic operation on each cluster to remove the clusters containing a relatively small number of points as noise; and
selecting a point with a maximum curvature in each remaining cluster as the block feature point.

7. The method according to claim 2, wherein the calculating curvature variations comprises:
calculating a curvature value for each point; and
calculating the curvature variation for each point based on the curvature value of each point.

8. The method according to claim 2, wherein the decomposing the shape based on regional growth comprises:
starting from the block feature point;
sorting the nearest neighbor points in a descending order of curvature values;
selecting the point with a maximum curvature as a seed point;
classifying the point with a small curvature variation into the same cluster as the seed point; and
repeating the above steps for the other points until all points are classified.

9. The method according to claim 3, wherein the extracting initial skeletons for the a non-annular surface comprises:
constructing a function for evaluating centrality of the model:
g(p)=Σ_{p∈P}G²(p, pᵢ)
where p is a point of the model, pi is another point of model, and G²(•, •) represents a geodetic distance between the two points; and
estimating a shortest path from each block feature point in T to the center point of the model using Dijkstra shortest path algorithm, and taking the points located on the paths as the initial surface skeletons for the non-annular surface L={L₁, L₂, . . . , Lₖ} of the model.

10. The method according to claim 3, wherein the determining a boundary comprises:
for two different decomposition regions Ri and Rj, recognizing points where an identifier change occurs as boundary points; and
determining identifier changes of the nearest neighbor points with respect to the boundary point and counting frequency of the changes; and
determining the points with the identifier i or j in the set of nearest neighbor points as points on the boundary.

11. The method according to claim 10, wherein the extracting skeletons for an annular surface comprises:
for the model with an annular structure, determining a boundary between two arbitrary regions and clustering the boundaries to separate two boundaries of the annular structure, that is, dividing the model with the annular structure into models with no annular structure;
determining a centroid of each boundary; and
calculating shortest paths from the block feature points to the centroid point of the boundary and a shortest path from the boundary centroid point to the center point of the model respectively, so that the points on these paths form the initial surface skeleton points of the annular object.

12. The method according to claim 3, wherein the determining centralized skeletons comprises:
moving all points of the initial skeletons of the non-annular surface and the initial skeletons of the annular surface toward the inside of the model using a 3D model skeleton pushing method to obtain the centralized skeletons.

13. The method according to claim 12, wherein the extracting simplified skeletons comprises:
identifying different decomposition parts;
determining block feature points for each decomposition part and determining a shortest path from each block feature point to the center of the model;
determining a connection portion between two different parts by detecting identifier changes of points on the shortest paths; and
simplifying the points on the shortest paths of different decomposition parts based on the connection portion.

14. The method according to claim 1, further comprising constructing a shape semantic description graph expressed as G=<V, E>, wherein:
V={V₁, V₂, V₃, . . . , Vₖ}, which represents nodes of respective decomposition parts;
E={E₁, E₂, . . . , Eₖ₋₁}, which describes a topological relationship between two decomposition parts as to whether they are adjacent to each other; and
determining an edge between two points if the two points have different identifiers, so as to obtain the shape semantic description graph of the entire model.
